(19) United States
(12) Patent Application Publication
(10) Pub. No.: US 2016/0034978 A1
(43) Pub. Date: Feb. 4, 2016

(54) METHOD, SYSTEM AND APPARATUS FOR ASSOCIATING MERCHANT-SUPPLIED INFORMATION WITH A FIXED REFERENCE POINT IN A VIRTUAL THREE-DIMENSIONAL WORLD

(71) Applicant: Tyrone J. KING, Palatine, IL (US)

(72) Inventor: Tyrone J. KING, Palatine, IL (US)

(21) Appl. No.: 14/451,345

(22) Filed: Aug. 4, 2014

(51) Int. Cl. G06Q 30/02; G06T 19/00; G06F 3/0481

(52) U.S. Cl. CPC G06Q 30/0277; G06F 3/04815; G06T 19/003; G06F 2203/04802; G06T 2200/04; G06T 2219/004

(57) ABSTRACT

A system, method and apparatus are provided for associating interactive virtual advertisements and/or merchant-supplied commercial information with one or more reference points plotted within a geolocated, three-dimensional, virtual world stored in a computer-readable database. In some embodiments, this virtual world comprises panoramic images aligned using Google® Photo Sphere technology within applications such as Google® Maps Business View.

### BACKGROUND

1. Field of the Invention

This invention relates to the display of merchant-provided information within a virtual three-dimensional world, and more particularly relates to fixing a reference point within a virtual rendition of the interior of a merchant's business for association with the merchant-provided information for marketing purposes.

2. Description of the Related Art

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

In 2010, Google launched an application entitled Google Business View, later renamed Google Maps Business View, for virtually rendering panoramic interior images of merchant business locations in three-dimensions. This technology was based on the previously released Google® Photo Sphere application for photographers, which “stitches,” or aligns, panoramic images on a virtual photo sphere. The virtual photo spheres were geolocated and accessible via Google Street View or a Google API.

Presently, the panoramas are gathered on location by Google “trusted photographers” before being uploaded to Google Business Photos (GBP) database. Google Maps Business View renders the panoramas via a web browser and simulates movement within the interior of a merchant's location as a user navigates the interior by interfacing with a compass icon or virtual arrows imposed on the full-surround imagery. Each featuring of a business in this manner is called a “tour.”

Business interior views are shown in Google Street View as small orange circles or icons. Businesses such as shops, cafes and other premises can pay a trusted photographer to take panoramic images of the interior of their premises which are then included in Street View. Businesses may also feature, currently, up to ten point of interest photographs in a virtual carousel disposed beneath the virtual rendering of the merchant business interior. Although Google presenting has over 250,000 tours available online, none have clickable elements from the businesses being toured.

Systems and techniques for stitching panoramas together, or changing the perspective of a visible image in producing a resultant image, or systems and methods of transforming an image from one perspective form to another have been the subject of several patents and many years of research years. Systems and techniques for transforming visible images include perspective generation systems and methods.

Several US patents disclose methods, systems and apparati for rendering groupings of images in virtual 3D, including U.S. Pat. No. 3,725,563, which teaches raster scanning transformations using rectangular coordinates; U.S. Pat. No. 4,763,280 which discloses a curvilinear dynamic image generation system; U.S. Pat. No. 4,821,209 which teaches a method of and apparatus for data transformation by matrix multiplication; and U.S. Pat. No. 4,667,236 discloses a television perspective effects system for providing perspective projection whereby each point of a three-dimensional object is projected onto a two-dimensional plane. Other patents teach methods of digitizing image data to correspond to intersection points on a rectangular X, Y grid are transposed by interpolation with respect to intersection points of a curved surface.

However, none of the above described methods or systems allow merchants whose business interiors are being digitally rendered to associate retail pricing, product offers, product specification, or other commercial information with objects, reference points, or hotspots within the virtual rendering. Such information would be beneficial to consumers and patrons of businesses needing not just interior view of a business location, but also information on products and offerings of the business.

In view of the foregoing, it is clear that existing methods and systems leave room for more optimal approaches to familiarizing a consumer with existing businesses. What is needed is a method, system and apparatus for associating merchant-supplied information with a fixed reference point within a virtual rendition of the business interior.

### SUMMARY

From the foregoing discussion, it should be apparent that a need exists for a method, system and computer program product for associating merchant-supplied information with a hotspot within a virtual world. The present invention recites a computer readable medium having computer usable program code executable to perform operations for associating merchant-supplied information with a hotspot within a geolocated virtual three-dimensional world, the operations of the computer program product comprising: creating a virtual account for a merchant by collecting and storing a merchant's name, address, and telephone number in persistent computer readable storage in a database in connection with a plurality of other virtual accounts; rendering in virtual three-dimensions panoramas of an interior of a merchant business in a web browser; prompting the merchant to identify a hotspot within the virtual three-dimensional rendering, the hotspot positioned over a product shown in the rendering; prompting the merchant to upload promotional data concerning the product; exclusively associating the promotional data in the virtual account with the hotspot; and displaying the promotional data in the rendering when a consumer scrolls over it with a mouse-operated cursor.

In some embodiments, a Google Maps Business View API is used to render the panoramas of the interior of a merchant business. In other embodiments, the promotional data comprises text, stylized trademarks, and hyperlinks to third-party websites. The computer program product may further comprise rendering the hotspot for a consumer in a color identified by the merchant; and rendering the hotspot with an icon uploaded by the merchant to signify that the promotional data is available if the consumer mouses over the hotspot with a cursor.

A system for associating merchant-supplied information with a hotspot within a geolocated virtual three-dimensional world is also provided, the modules of the system comprising: a creator module configured to create a virtual account for a merchant by collecting and storing a merchant's name, address, and telephone number in persistent computer readable storage in a database in connection with a plurality of other virtual accounts; a render module configured to render in virtual three-dimensions panoramas of an interior of a merchant business in a web browser; a prompter module configured to prompt the merchant to identify a hotspot within the virtual three-dimensional rendering, the hotspot positioned over a product shown in the rendering; an uploader module configured to prompting the merchant to upload promotional data concerning the product; an associate module configured to exclusively associating the promotional data in the virtual account with the hotspot; and a displayer module configured to display the promotional data in the rendering when a consumer scrolls over it with a mouse-operated cursor.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a user interface of a conventional Internet browser in accordance with the present invention;

FIG. 2 illustrates a user interface of a conventional Internet browser in accordance with the present invention;

FIG. 3 illustrates a user interface of a conventional Internet browser in accordance with the present invention;

FIG. 4 is a flowchart diagram of an exemplary method for associating merchant-provided information with a fixed point within a virtual three-dimensional world, in accordance with the present invention; and

FIG. 5 is an entity-relationship diagram illustrating the relationship between entities working in concert to associate merchant-provided information with a fixed point within a virtual three-dimensional world in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

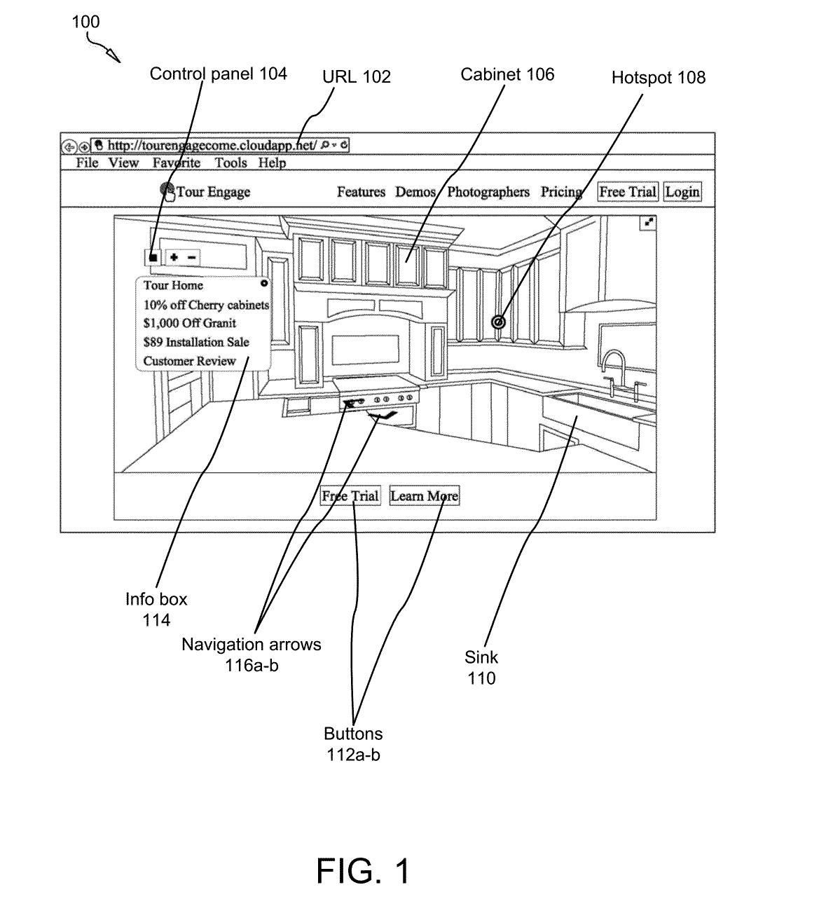

FIG. 1 illustrates a computer program product 100 displaying a user interface within a conventional browser. The user interface comprises a control panel 104, a hotspot 108, buttons 112a-b, navigation arrows 116a-b, and virtual images of a cabinet 106 and a sink 110. The browser comprises a URL 102.

The user interface functionality is realized by means of the computer program product, which lays, or imposes, elements over the top of a Google virtual tour. In the shown embodiments, the sink 110 and cabinet 106 are displayed virtually by Google, but the info box 114, navigation arrows 116a-b, buttons 110a-b, hotspot 108, and control panel 104 a laid over the Google virtual display by the computer program product 100.

The computer program product 100 prompts a merchant to register for an account with a server storing the computer program product 100. The server comprises a system or computer program running on one or more data processing devices (DPDs), such as a server, computer workstation, router, mainframe computer, or the like. In various embodiments, the DPD comprises one or more processors. The processor is a computing device well-known to those in the art and may include an application-specific integrated circuit (“ASIC”).

The server comprises a database management system (DBMS) or relational database management system (RDBMS), such as Oracle, SQL, FireBird, IBM DB2®, or the like. Merchants access or login to an account they have with the server before uploading promotional information. These merchant upload both promotional information for display and identifying information which the merchants use to create an account with the server, in which account membership information is stored in computer readable database memory accessible by server.

The personal identifying information is stored in a database; and may comprise identifying information, such as a merchant name, address, email, telephone, IP address information, age, address, gender, banking information, credit rating, email, telephone number, income, and education.

In the present invention, the server interconnects one or more consumers and merchants via the browser, accessible. The server may, in typical embodiments, be in logical communication with consumers through a networked environment, such as local area network (LAN) or wide area network (WAN). The server may relay communication prompting a consumer to access a browser using means known to those of skill in the art, including variations of the Simple Mail Transfer Protocol (SMTP), Internet Message Access Protocol (IMAP), Post Office Protocol (POP), File Transfer Protocol (FTP), or other protocols.

The consumers via browsers using data processing devices (DPDs), which, in the preferred embodiment, comprise smart phones including iPhone, Android, Palm Pilots®, and the like. These DPDs may even comprise digital cameras or laptops, etc. The computer program product 200 may be designed with responsive web design (RWD) technology.

Merchants who have registered and created an account with the server and who have had their place of business photographed by a Google trusted photographer may “drop hotspots” wherever they would like within the virtual tour, which denotes identifying a fixed reference point within the three-dimensional rendering of the business interior with which hotspot will be used to associate promotional data by the merchant.

Though their registered accounts, merchants may associate promotional offers and/or other commercial information with hotspots. This promotional data may comprise offers for discounts on products or services, information about existing products or services, or other merchant-related information, including employment opportunities or technical information.

In various embodiments of the present invention, the hotspot may serve not just as an identifier of the availability of promotional information but also as an anchor within the virtual tour itself around which the consumer axially rotates perspective view of the merchant interior.

In short, merchants drop a point on the virtual rendering, which is geolocated using Google photosphere technology, and the merchant and adds interactivity. Google may promote the computer program product as an alternative to viewing a tour without merchant information.

The server may comprise a computer-implemented system including a memory, a storage device and a processing unit, the memory storing a set of instructions, which, when executed by the processing unit causes the processing unit to perform a method for displaying promotional materials to a user using a browser executing on a client computer. The method involves receiving personal information from Internet resources, the personal information being related to the merchants business objectives; receiving the promotional information from the one or more internet resources in response to the request; and associating the received promotional information with a hotspot.

In some embodiments, Google technology is excluded in creating the virtual tour. New coordinates X′ and Y′ are prepared from the original coordinates X, Y and, and the viewing distance D, and the hotspot is associated with the new coordinates. As perspective of the interior to be displayed is rotated around the X or Y axis, the viewing distance D is changed for each hotspot. The panoramic images may also be rendered stereoscopically using anaglyphs.

The control panel 104 may comprise any of a plurality of interactive virtual buttons for improving or realizing consumer navigation, including a compass icon, image carousel, thumbnails, navigation arrow, info cards, imagery, pegman, hotspots, scales, slides or using other means.

The displayed merchant interior is depicted as a kitchen, having a sink 110 and cabinet 106. The merchant interior may be an interior or exterior of any building, fixture, or property. The property may be under the control of any entity with any legal interest in the property.

In various embodiments, the hotspot 108 is fixed within the virtual rendering on top of a product being retailed or wholesaled by the entity and/or merchant controlling the property. For instance, the hotspot 108 may be affixed upon a computer being offered for sale by an electronic's retailer.

The info box 114 displays promotion data and commercial data uploaded by the merchant to the server. In some embodiments, the info box when the hotspot 108 is scrolled over with the mouse cursor or clicked on with a mouse cursor.

The tour is navigated with the navigation arrows 116a-b and or controls appearing in the control panel 104.

In various embodiments, additional promotional data uploaded by the merchant is available when the buttons 112a-b are clicked on activated.

In various embodiments of the present invention, the info box 114 and control panel 104 are overlaid on the rendered Google Street View or Google Maps Business View tours. Interactivity and/or navigation controls are overlaid on the Google rendering by the computer program product.

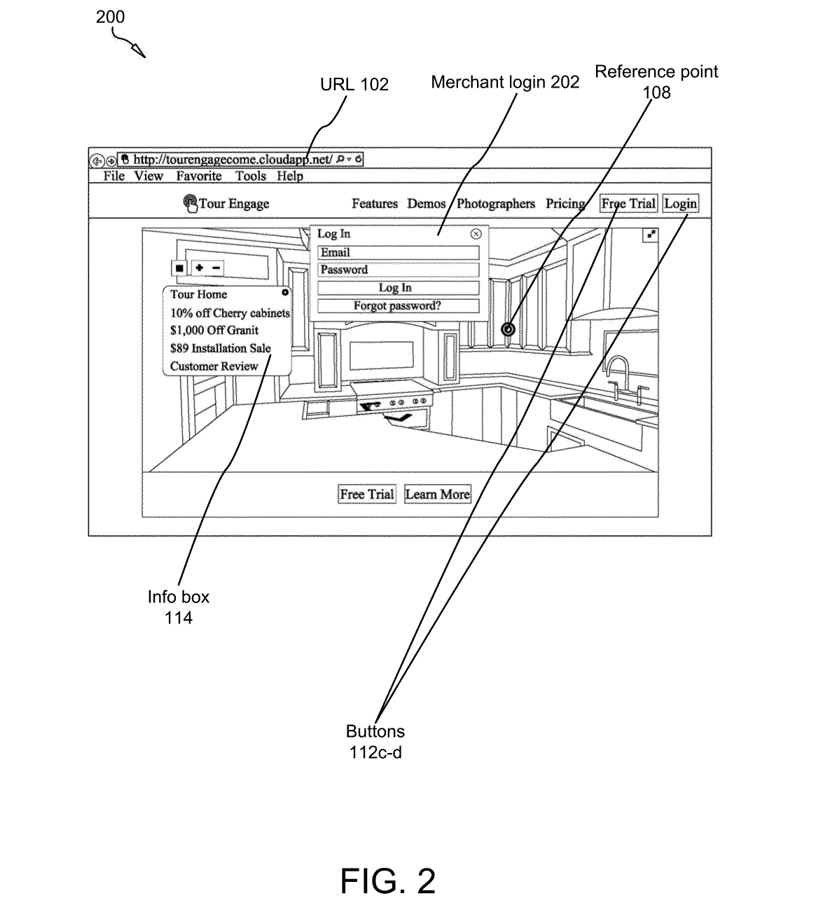

Turning now to FIG. 2. FIG. 2 illustrates a user interface of a conventional Internet browser in accordance with the present invention. The user interface is controlled by a computer program product 200. The user interface comprises a merchant login 202, which provides the functionality allowing a merchant to login to a previously created account for uploading promotional data or personal identifying information.

As shown, an entity or merchant is prompted to login and/or register for an account by the computer program product.

The computer program product 200 provides features and functionality which allows branding opportunities to merchants, including logo display and customizable hotspots and navigation.

Hotspots 108 are customizable, meaning each hotspot may be fixed as a reference point within the tour, but also each hotspot 108 can have its own icon(s) that displays over a product/position within the tour to signify that further information is available to a consumer and can be easily viewed within the virtual tour.

The navigation controls for the computer program product 200 remain open and visible to visitors throughout the entirety of the tour. The menu of navigational options is also customizable—allowing users to change color scheme and branding. The computer program product may provide consumers with a selection of different advertising and promotional options that can be accessed, including informational videos, textual explanations, coupons, offers, online only discount, and availability information. Merchant administrators may add social sharing features in the info box 114 or promotional data.

A user interface of a conventional internet browser is illustrated in FIGS. 1-3. The browser window incorporates a top bar as well having a URL 102, and may incorporate one or more toolbars, including field and input controls for inputting the URL 102 into the browser. The user interface may comprise drop-down menus.

In various embodiments, the merchant or entity controlling the interior being depicted by the computer program product has a leasehold estate property interest in the property being depicted, or a freehold interest, or any other type of estate in land.

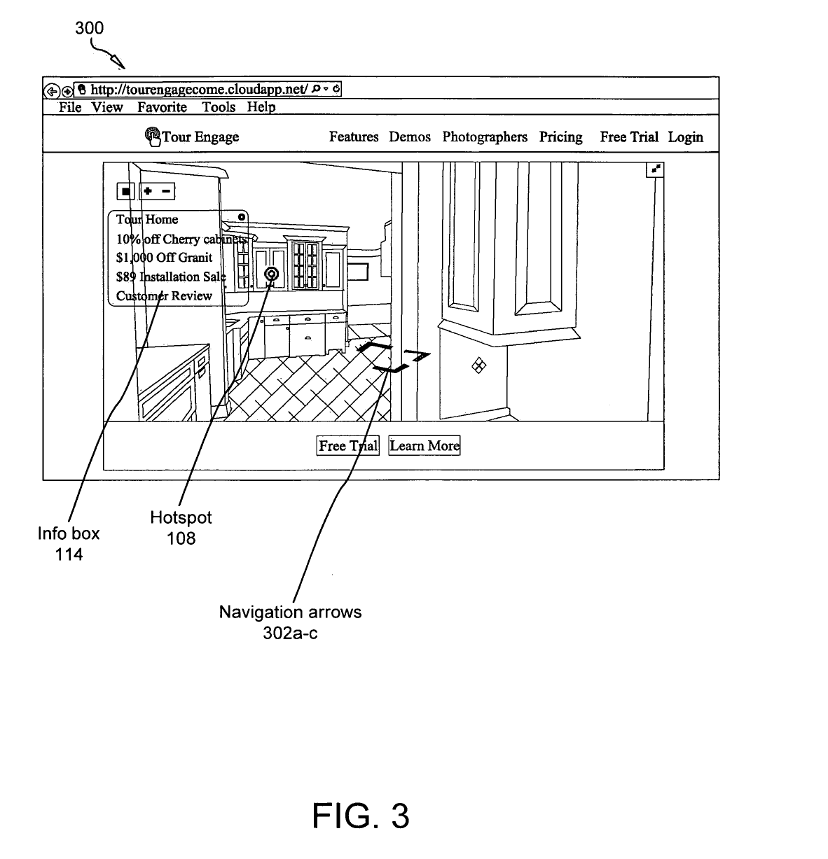

FIG. 3 illustrates a user interface of a conventional Internet browser in accordance with the present invention.

The info box 114 may be transparent, showing the virtual rendering behind the info box 114.

The hotspot 108 shown remains static in a geolocated position from one panorama to another within the same tour.

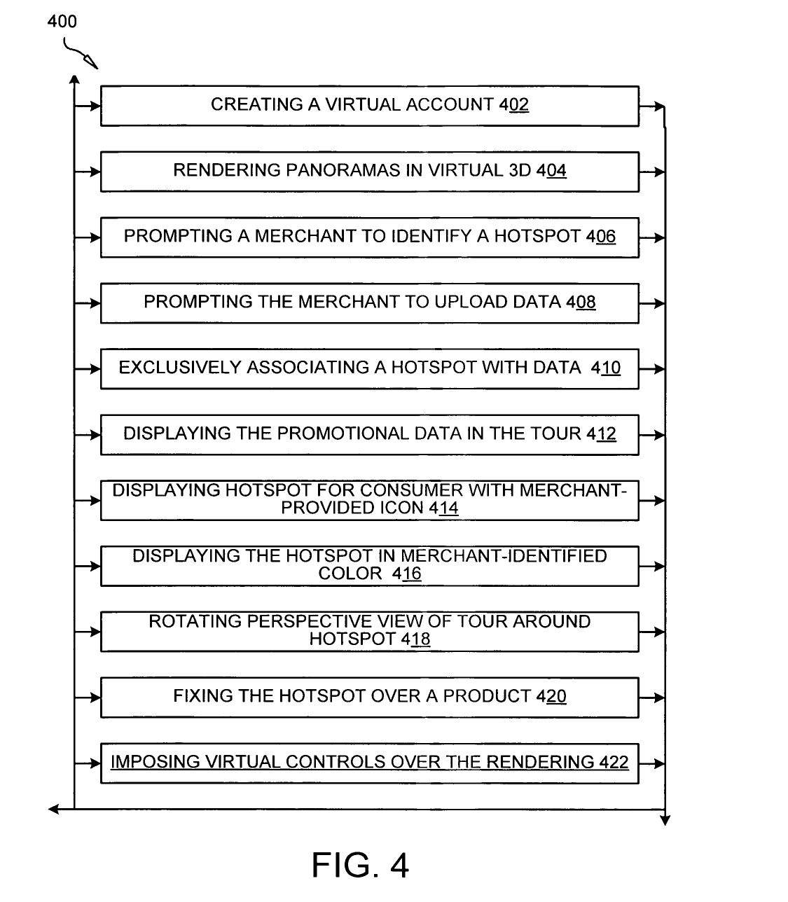

FIG. 4 is a flowchart diagram of an exemplary method 400 for associating merchant-provided information with a fixed point within a virtual three-dimensional world, in accordance with the present invention.

The steps of the method begin with the creation 402 of a merchant or entity account. In various embodiments, the entity registers for an account with the computer program product, apparatus or system and uploads one or more of name, address, email address, telephone number, and a category of business.

Once the merchant or entity is registered, the entity may access or upload panoramas for use in the virtual tour. The entity may also position, fix or identify a hotspot 108 within the tour.

Panoramas of the tour are stitched together and rendered 404 in virtual three-dimensions for users, the merchant and consumers via a web browser. The merchant is prompted 406 to identify, or fix 420, a hotspot 108 within the rendering/tour.

The entity or merchant is prompted 408 to upload data, including promotional data, text, and/or hyperlinks to third-party websites. This data, or promotional data, may be exclusively associated with a hotspot 108 such that the promotional data appears, or is displayed 412, when the hotspot 108 is clicked on or cursed over with a cursor. Additional promotional data may be uploaded by the merchant may be associated the hotspot 410.

The hotspot 108 selected by the merchant is rendered for the consumer in the tour. The hotspot 108 may be rendered or displayed 414 using an icon in computer readable memory, or may be selected and/or uploaded by the merchant. In various embodiments, a plurality of hotspots are selected by the merchants. In various embodiments, the hotspots 108 are color-coordinated in accordance with a color scheme in which each color is associated with a category of product or service. The color of the hotspots 108 may alternatively be selected and displayed 416 by the merchant and/or user for other purposes. In various embodiments, the icon representing the hotspot 108 may blink, flash, fade, or virtually rotate.

Using Google-provided navigation controls or navigation control imposed 422 by the computer program product over the Google rendering to navigate the tour and rotate 418 through panoramic images forming the tour.

The term “entity” is defined for the purposes of the application as comprising any individual, business, merchant, governmental organization or corporation.

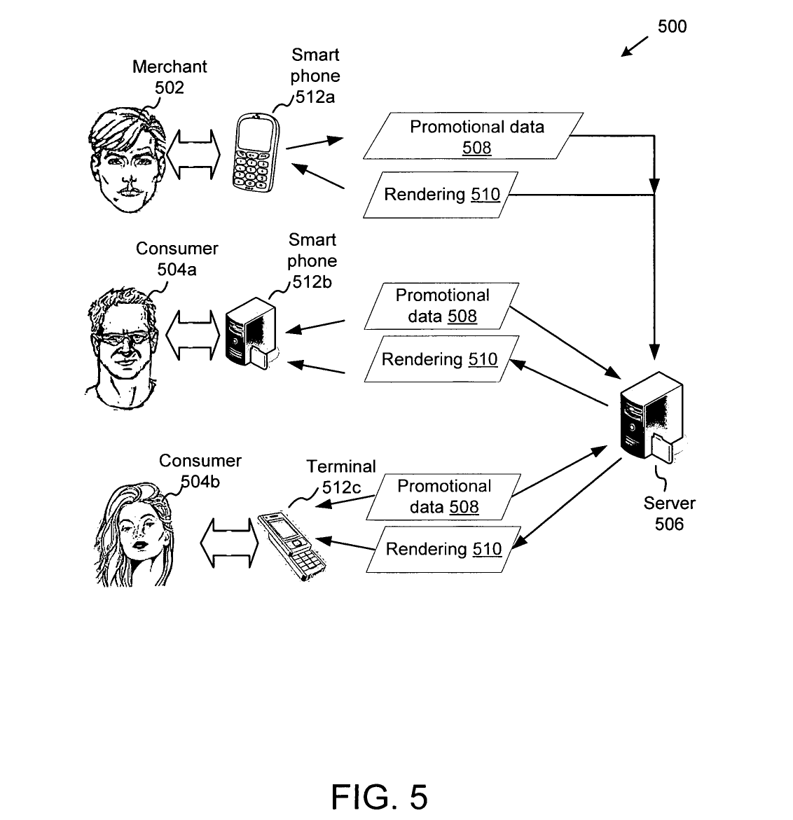

FIG. 5 is an entity-relationship diagram illustrating the relationship 500 between entities working in concert to associate merchant-provided information with a fixed point within a virtual three-dimensional world in accordance with the present invention.

The merchant 502 communicates via a wireless network using a DPD 512a to upload promotional data 508 to the server 506. A rendering 510 of the interior of the building is displayed for and shown to the merchant 502 in a browser on the smart phone 512.

Consumers 504b-c also view renderings 510 of the interior of the business, but renderings 510 that are overlaid with promotional data 508.

The relationship 500 includes a multiplicity of consumers and merchants interacting over a multiplicity of local networks such as LANs or WANs. Consumers may communicate bi-directionally with local network via a communication channel.

It will be understood by those skilled in the art that communication system may take many different forms. Non-limiting examples of forms for communication system include local area networks (LANs), wide area networks (WANs), wired telephone networks, wireless networks, or any other network supporting data communication between respective entities.

Consumers and merchants may take many different, forms. Non-limiting examples of consumers and merchants include personal computers, personal digital assistants (PDAs), cellular phones and smartphones. The consumer may comprise a CPU, a pointing device, a keyboard, a microphone, a printer, a memory, a mass memory storage, a GUI, a video camera, an input/output interface and a network interface.

CPUs may be comprised of a single processor or multiple processors. CPU may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

Memory, as discussed previously, may include any suitable computer-readable media, intended for data storage, such as those described above excluding any wired or wireless transmissions unless specifically noted. Mass memory storage may also be coupled bi-directionally to a CPU and provides additional data storage capacity and may include any of the computer-readable media described above. Mass memory storage may be used to store programs, data and the like and is typically a secondary storage medium such as a hard disk. It will be appreciated that the information retained within mass memory storage, may, in appropriate cases, be incorporated in standard fashion as part of memory as virtual memory.

The CPU may be coupled to keyboard. The keyboard enables a user with the capability to input alphanumeric textual information to the CPU. The CPU may be coupled to microphone. The microphone enables audio produced by a user to be recorded, processed and communicated by the CPU. The CPU may be connected to a printer. The CPU may also be coupled to input/output interface that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising a computer readable medium having computer usable program code executable to perform operations for associating merchant-supplied information with a hotspot within a geolocated virtual three-dimensional world, the operations of the computer program product comprising:
creating a virtual account for an entity by collecting and storing the entity's name, address, and telephone number in persistent computer readable storage in a database in connection with a plurality of other virtual accounts;
rendering in virtual three-dimensions panoramas of an interior of a business interior in a web browser;
prompting the entity to identify a hotspot within the virtual three-dimensional rendering, the hotspot positioned over a product shown in the rendering;
prompting the entity to upload promotional data concerning the product;
exclusively associating the promotional data in the virtual account with the hotspot; and
displaying the promotional data in the rendering when a consumer scrolls over it with a mouse-operated cursor.

2. The computer program product of claim 1, wherein a Google Maps Business View API is used to render the panoramas of the interior of a merchant business.

3. The computer program product of claim 1, wherein the promotional data comprises text, stylized trademarks, and hyperlinks to third-party websites.

4. The computer program product of claim 1, further comprising rendering the hotspot for a consumer in a color identified by the merchant; and rendering the hotspot with an icon uploaded by the merchant to signify that the promotional data is available if the consumer mouses over the hotspot with a cursor.

5. A computer program product comprising a computer readable medium having computer usable program code executable to perform operations for associating merchant-supplied information with a hotspot within a geolocated virtual three-dimensional world, the operations of the computer program product comprising:
imposing interactive controls over a virtual three-dimensional rendering of a building interior, the interactive controls comprising:
a hotspot identified with an entity-selected icon, the hotspot fixed to appear in a static geolocated position anywhere within the rendering;
promotional information exclusively associated with the hotspot, the promotional data comprising one or more of a price, a hyperlink to a third-party website, and text;
navigation controls for navigating the panoramas forming the rendering;
prompting an entity to fix the position of the hotspot within the virtual three-dimensional rendering; and
prompting the entity to upload the promotional data concerning the product.

6. The computer program product of claim 5, further comprising a virtual carousel displaying pictures selected by the entity.

7. The computer program product of claim 5, wherein the hotspot is fixed on a product shown in the virtual rendering.

8. The computer program product of claim 5, further comprising prompting the entity to fix positions of a plurality of hotspots within the virtual three-dimensional rendering.

9. The computer program product of claim 8, further comprising prompting the entity to upload secondary promotional data for exclusive association with one of the plurality of hotspots.

10. A system for associating merchant-supplied information with a hotspot within a geolocated virtual three-dimensional world, the modules of the system comprising:
a creator module configured to create a virtual account for a merchant by collecting and storing a merchant's name, address, and telephone number in persistent computer readable storage in a database in connection with a plurality of other virtual accounts;
a render module configured to render in virtual three-dimensions panoramas of an interior of a merchant business in a web browser;
a prompter module configured to prompt the merchant to identify a hotspot within the virtual three-dimensional rendering, the hotspot positioned over a product shown in the rendering;
an uploader module configured to prompting the merchant to upload promotional data concerning the product;
an associate module configured to exclusively associating the promotional data in the virtual account with the hotspot; and
a displayer module configured to display the promotional data in the rendering when a consumer scrolls over it with a mouse-operated cursor.

11. The system of claim 5, wherein a Google Maps Business View API is used to render the panoramas of the interior of a merchant business.

12. The system of claim 5, wherein the promotional data comprises text, stylized trademarks, and hyperlinks to third-party websites.

13. The system of claim 5, further comprising rendering the hotspot for a consumer in a color identified by the merchant; and rendering the hotspot with an icon uploaded by the merchant to signify that the promotional data is available if the consumer mouses over the hotspot with a cursor.
